(19) United States
(12) Patent Application Publication
(10) Pub. No.: US 2022/0371677 A1
(43) Pub. Date: Nov. 24, 2022

(54) Training Wheel Training Device

(71) Applicant: Aharon A. Karan, Glendale, WI (US)

(72) Inventor: Aharon A. Karan, Glendale, WI (US)

(21) Appl. No.: 17/751,056

(22) Filed: May 23, 2022

Related U.S. Application Data
(60) Provisional application No. 63/192,373, filed on May 24, 2021.

(51) Int. Cl. B62H 7/00

(52) U.S. Cl. CPC B62H 7/00

(57) ABSTRACT

A training wheel training device is provided for use in connection with a bicycle having first and second training wheels mounted thereto. The training wheel device includes a block having a bottom surface engageable with a supporting surface and an upper surface spaced therefrom. The upper surface includes a recess formed therein. A wheel support surface has at least a portion spaced from the upper surface and partially defines the recess. The wheel support surface is adapted for receiving the first training wheel.

### FIELD OF THE INVENTION

This invention relates generally to bicycles, and in particular, to a training wheel training device for use in connection with a bicycle having training wheels which assists a child in learning how to ride a bicycle and which allows the bicycle to be used as exercise equipment for indoor cycling.

### BACKGROUND AND SUMMARY OF THE INVENTION

Training wheels for bicycles are widely known in the art. As is known, training wheels are wheels mounted parallel to the rear wheel of a bicycle that they are used to teach an individual to ride a bicycle, by assisting the individual in developing a sense of balance on the bicycle. More specifically, the training wheels are mounted on opposite sides of a bicycle frame adjacent the rear wheel of two-wheeled bicycles by means of downwardly and outwardly divergent training wheel support brackets. The training wheels allow the individual to operate the bicycle in a conventional manner by pedaling the pedals thereof, while preventing the bicycle from tipping over when the bicycle is rode by the individual.

Similarly, bicycle stands for supporting conventional bicycles for indoor exercises are widely known in the art. Typically, a bicycle stand includes a base with a pair of upright supports. The supports have a capture means to hold the rear axle of the bicycle off the ground and to optionally position the outside of the wheel to bear against a drag means. The drag means provides variable resistance as the user peddles. The prior art teaches a number of exercise stands that are adapted to a particular diameter wheel and a wheel width. However, it can be appreciate that an ongoing need exists for a training wheel training device for use in connection with a bicycle having training wheels which assists a child in learning how to ride a bicycle and which allows the bicycle to be used as exercise equipment for indoor cycling.

Therefore, it is a primary object and feature of the present invention to provide a training wheel training device for use in connection with a bicycle having training wheels which assists a child in learning how to ride a bicycle.

It is a further object and feature of the present invention to provide a training wheel training device for use in connection with a bicycle having training wheels which allows the bicycle to be used as exercise equipment for indoor cycling.

It is a still further object and feature of the present invention to provide a training wheel training device for use in connection with a bicycle having training wheels which is simple to use and inexpensive to manufacture.

In accordance with the present invention, a training wheel training device is provided for use in connection with a bicycle having first and second training wheels mounted thereto. The training wheel device includes a block having a bottom surface engageable with a supporting surface and an upper surface spaced therefrom. The upper surface includes a recess formed therein. A wheel support surface has at least a portion spaced from the upper surface and partially defines the recess. The wheel support surface is adapted for receiving the first training wheel.

The block includes first and second sidewalls. Each of the first and second sidewalls includes an inner surface partially defining the recess and an upper edge partially defining the upper surface of the block. The upper edge of the first sidewall includes a notch. The notch is defined by first and second side surfaces interconnected by a lower surface spaced from the upper edge. The first and second side surfaces include lower portions extending from opposite ends of the lower surface and upper portions between the lower portions and the upper edge. The lower portions of the first and second side surfaces are generally parallel to each other. The upper portions of the first and second side surfaces extend from the upper edge and converge toward each other.

The wheel support surface is generally arcuate and has first and second ends intersecting the upper surface of the block. The block is a first block and the wheel support surface is a first wheel support surface. The training wheel training device may also include a second block having lower surface engageable with the supporting surface and an upper surface spaced therefrom. The upper surface of the second block includes a recess formed therein. A second wheel support surface has at least a portion spaced from the upper surface of the second block and partially defines the recess of the second block. The second wheel support surface is adapted for receiving the second training wheel.

In accordance with a further aspect of the present invention, a training wheel training device is provided for use in connection with a bicycle having a training wheel. The training wheel is supported by a support extending from a frame of the bicycle. The training wheel training device includes a block having lower surface engageable with a supporting surface, an upper surface spaced therefrom, a first sidewall having an upper edge and a second sidewall. The upper surface includes a recess configured to receive at least a portion of the training wheel formed therein. A notch is formed in the upper edge of the first sidewall and is configured to allow the support of the bicycle to pass therethrough. The notch communicates with the recess.

A wheel support surface has at least a portion spaced from the upper surface and partially defines the recess. The wheel support surface is adapted for engagement with the training wheel. Each of the first and second sidewalls includes an inner surface also partially defining the recess and an outer surface. The outer surface of the first sidewall includes a lower portion extending from the lower surface of the block and upper portion between the lower portion and the upper edge.

The notch is defined by first and second side surfaces interconnected by an end surface spaced from the upper edge. The first and second side surfaces include lower portions extending from opposite ends of the end surface and upper portions between the lower portions and the upper edge. The lower portions of the first and second side surfaces are generally parallel to each other. The upper portions of the first and second side surfaces extend from the upper edge and converge toward each other. The wheel support surface is generally arcuate and has first and second ends intersecting the upper surface of the block.

In accordance with a still further aspect of the present invention, a training wheel training device is provided for use in connection with a bicycle having a first and second training wheels. Each of the first and second training wheels supported by a corresponding support extending from a frame of the bicycle. The training wheel training device includes first and second blocks. Each of the first and second blocks has a lower surface engageable with a supporting surface, an upper surface spaced therefrom, a first sidewall having an upper edge and a second sidewall. The upper surface including a recess configured to receive at least a portion of the training wheel formed therein. A notch is formed in the upper edge of the first sidewall and is configured to allow the support of the bicycle to pass therethrough. The notch communicates with the recess. A wheel support surface has at least a portion spaced from the upper surface and partially defines the recess. The wheel support surface is adapted for receiving a corresponding one of the first and second first training wheels thereon.

The first and second sidewalls of each of the first and second blocks include an inner surface partially defining the recess. The notch in each of the first and second blocks is defined by first and second side surfaces interconnected by a bottom surface spaced from the upper edge. The first and second side surfaces include lower portions extending from opposite ends of the bottom surface and upper portions between the lower portions and the upper edge. The lower portions of the first and second side surfaces of each notch are generally parallel to each other. The upper portions of the first and second side surfaces of each notch extend from the upper edge of a corresponding first sidewall of the first and second blocks and converge toward each other. The wheel support surface of each of the first and second blocks is generally arcuate and has first and second ends intersecting the upper surface of a corresponding first and second block.

### BRIEF DESCRIPTION OF THE DRAWINGS

Preferred exemplary embodiments of the invention are illustrated in the accompanying drawings in which like reference numerals represent like parts throughout, and in which:

FIG. 1 is a rear elevational view showing a bicycle with training wheels supported by a training wheel training device in accordance with the present invention;

FIG. 2 is an isometric view showing a rear portion of the bicycle of FIG. 1

FIG. 3 is an isometric view of the training wheel training device of the present application;

FIG. 4 is an end view of a first end of the training wheel training device of FIG. 3;

FIG. 5 is an end view of a second end of the training wheel training device of FIG. 3;

FIG. 6 is a side elevational view of a first side of the training wheel training device of FIG. 3;

FIG. 7 is a side elevational view of a second side of the training wheel training device of FIG. 3;

FIG. 8 is a top plan view of the training wheel training device of FIG. 3;

FIG. 9 is a bottom plan view of the training wheel training device of FIG. 3; FIG. 5 is a side elevational view of a second side of the door pull of FIG. 1;

FIG. 10 is an isometric view of a first side of a top portion of the training wheel training device of FIG. 3;

FIG. 11 is an isometric view of a second side of the top portion of the training wheel training device of FIG. 3;

FIG. 12 is a cross-sectional view of the training wheel training device of the present application; take along line 12-12 of FIG. 8; and

FIG. 13 is a cross-sectional view of the training wheel training device of the present application; take along line 13-13 of FIG. 8.

### DETAILED DESCRIPTION OF THE DRAWINGS

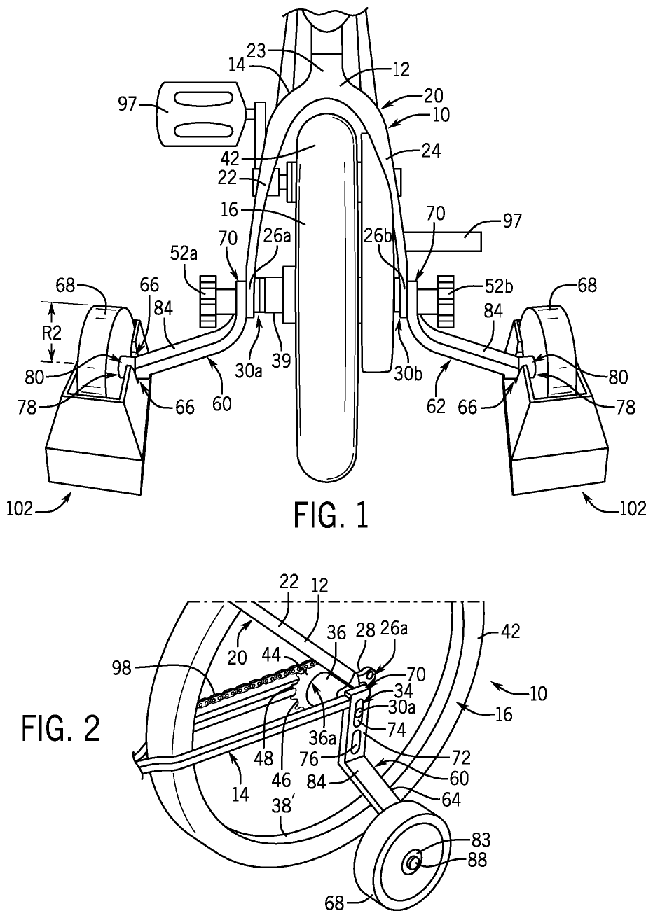

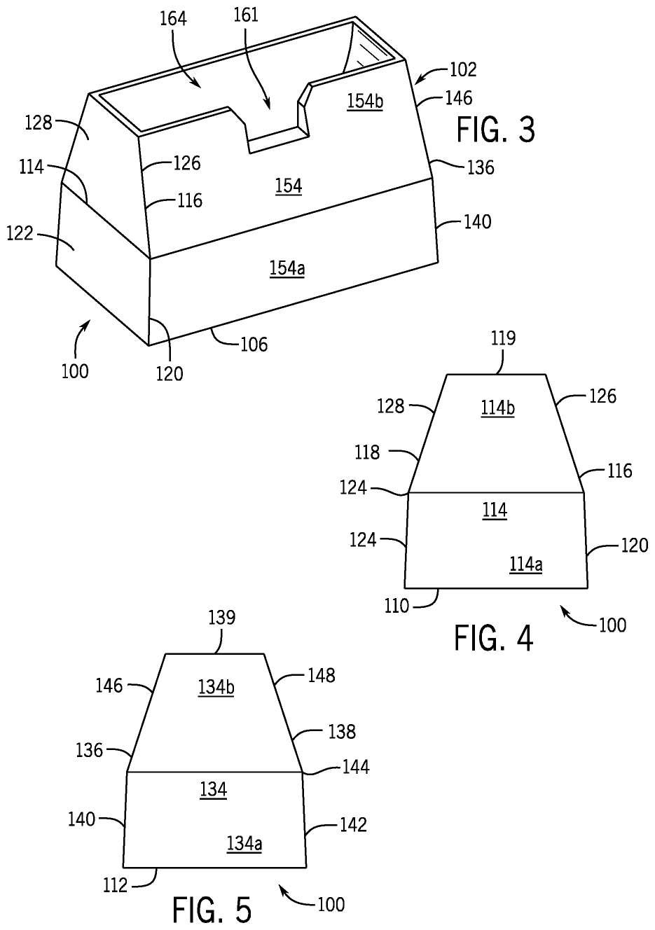

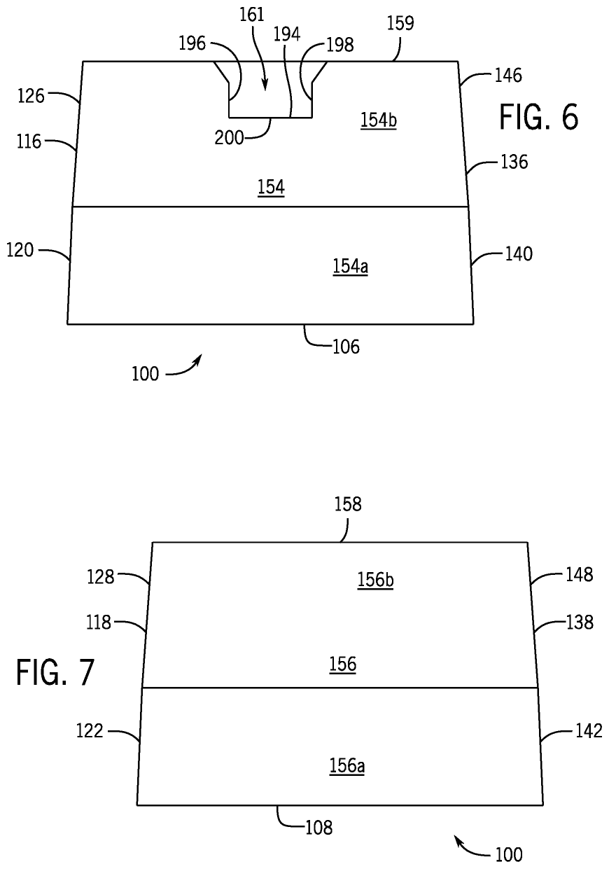

Referring to FIGS. 1-2, an exemplary bicycle for use in conjunction with a training wheel training device is generally designated by the reference numeral 10. Bicycle 10 includes frame member 12 having a rearward portion 14 adapted for supporting rear wheel 34. Frame member 12 is typically formed from tubular steel stock having a substantially circular cross section. However, frame member 12 may from other materials such aluminum, carbon fiber or titanium without deviating from the scope of the present invention.

Rearward portion 14 of frame member includes rear fork member 20 defined by a pair of spaced substantially parallel and substantially identical first and second rear forks 22 and 24, respectively. Each rear fork 22 and 24 is connected to central support 23 of the frame member 12 and terminates at a corresponding substantially flat plate 26a and 26b, respectively, having slots 28 formed therein which are adapted for receiving a corresponding first and second end portions 30a and 30b, respectively, of rear axle 32 of rear wheel 34, as hereinafter described.

As is conventional, rear wheel 34 of bicycle 10 includes a central hub 36 adapted for supporting rear axle 32 extending therethrough. Rim 38 is concentric with and interconnected to central hub 36 by a plurality of spokes (not shown) extending therebetween. Rim 38 is adapted for receiving tire 42 thereon. Chain driven sprocket 44 is interconnected to first side 36a of central hub 36 and projects radially therefrom. Radially outer edge 46 of chain driven sprocket 44 includes a plurality of teeth 48 adapted for forming a mating relationship with a drive chain 50. Rear axle 32 extends through central hub 36 such that first end portion 30a projects from first side 36a of central hub 36 and extends through chain driven sprocket 44 and such that second end portion 30b of rear axle extends projects from second side 36b of central hub 36 First and second end portions 30a and 30b, respectively, of rear axle 32 are threaded to allow for receipt of corresponding nuts 52a and 52b thereon.

As described, it order to connect rear wheel 34 to frame member 12, rear wheel 34 is positioned between first and second rear forks 22 and 24, respectively. First end portion 30a of rear axle 32 is inserted into slot 28 in plate 26a and second end portion 30b of rear axle 32 is inserted into slot 28 in plate 26b. As described, rear axle 32 spans first and second rear forks 22 and 24, respectively, of frame member 12 such that first end portion 30a of rear axle 32 projects laterally from slot 28 in plate 26a and such that second end portion 30b of rear axle 32 projects laterally from slot 28 in plate 26b.

First and second training wheel assemblies 60 and 62, respectively, are interconnected onto first end portion 30a of rear axle 32 and onto second end portion 30b of rear axle 32, respectively. First and second training wheel assemblies 60 and 62, respectively, are identical in structure, and as such, the following description of first training wheel assembly 60 is understood to describe second training wheel assembly 62 as if fully described herein. First training wheel assembly 60 includes rigid bracket 64 having a lower end 66 for rotatably supporting first training wheel 68 and an upper end 70 for operatively connecting first training wheel 68 to a corresponding end portion 30a and 30b of rear axle 32. Bracket 64 is defined by upright flat bike mounting portion 72 extending from upper end 70, terminating at an inner end 76, and having one or more elongated, spaced openings or slots 74, 76 formed therethrough to accommodate a corresponding end portion 30a and 30b of rear axle 32; a flat training wheel mounting portion 78 extending from lower end 66, terminating at an inner end 80 and having an aperture formed therethrough to accommodate bolt 83 for mounting a corresponding training wheel 68 to bracket 64; and intermediate portion 84 interconnecting inner end 76 of bike mounting portion 72 to inner end 80 of training wheel mounting portion 78. To interconnect each training wheel 68 to bracket 64, bolt 83 is inserted through an aperture through wheel mounting portion 78 and a central aperture in a corresponding training wheel 68. Nut 88 is threaded onto the end of bolt 83 to capture training wheel 68 to wheel mounting portion 78 of bracket 64.

To interconnect first training wheel assembly 60 to frame member 12 of bicycle 10, first training wheel assembly 60 is positioned on rear axle 32 such that first end portion 30a of rear axle 32 projects through a selected one of slots 74, 76 through bike mounting portion 72. Nut 52a is threaded onto first end portion 30a of rear axle 32, thereby capturing first training wheel assembly 60 on frame member 12 and securing real wheel 34 to frame member 12. With first training wheel assembly 60 interconnected to frame member 12, wheel mounting portion 78 of first training wheel assembly 60 lies in a plane generally parallel to and offset from bike mounting portion 72 of first training wheel assembly 60 such that training wheel 68 of first training wheel assembly 60 is positioned at a distance from flat plate 26a of frame member 12 and from the plane of rear wheel 34.

In the same matter, second training wheel assembly 62 is interconnected to frame member 12 of bicycle 10. More specifically, second training wheel assembly 62 is positioned on rear axle 32 such that second end portion 30b of rear axle 32 projects through a selected one of slots 74, 76 through bike mounting portion 72 of second training wheel assembly 62. Nut 52b is threaded onto second end portion 30a of rear axle 32 thereby capturing second training wheel assembly 62 on frame member 12 and further securing real wheel 34 to frame member 12. With second training wheel assembly 62 interconnected to frame member 12, wheel mounting portion 78 of second training wheel assembly 62 lies in a plane generally parallel to and offset from bike mounting portion 72 of second training wheel assembly 62 such that second training wheel 68 of second training wheel assembly 62 is positioned at a distance from flat plate 26b of frame member 12 and from the plane of the rear wheel 34.

With first and second training wheel assemblies 60 and 62, respectively, interconnected to frame member 12 of bicycle 10, bicycle 10 is positioned on supporting surface 96 such that rear wheel 34 engages supporting surface 96. It is intended for first and second training wheels 68 and 94, respectively, to either: 1) engage supporting surface 96; or 2) be spaced from supporting surface 96. As such, it can be appreciated that first and second training wheel assemblies 60 and 62, respectively, allow the individual to operate the bicycle in a conventional manner by pedaling pedals 97 thereof Bicycle 10 is powered by a rider pedaling pedals 97 of bicycle 10. The power generated by the user is directly transferred from pedals 97 to rear wheel 34 through chain 98 that interconnects pedals 97 to chain driven sprocket 44 of rear wheel 34, thereby propelling real wheel 34, and hence bicycle 10, over supporting surface 96. Training wheels 68 of first and second training wheel assemblies 60 and 62, respectively, prevent bicycle 10 from tipping over when bicycle 10 travels along supporting surface 10.

A training wheel training device for use in connection bicycle 10 is generally designated by the reference numeral 100. Training wheel training device 100 is defined by a pair of training blocks 102. Training blocks 102 are identical in structure, and as such, the following description is intended to fully describe each of the pair of training blocks 102 as if fully described herein.

Referring to FIG. 9, training block 102 includes a generally flat lower surface 104 defined by first and second side edges 106 and 108, respectively, interconnected by first and second end edges 110 and 112, respectively. First and second side edges 106 and 108, respectively, are parallel to each other and perpendicular to first and second end edges 110 and 112, respectively. Similarly, first and second end edges 110 and 112, respectively, are parallel to each other and perpendicular to first and second side edges 106 and 108, respectively. Lower surface 104 of training block 102 may include a plurality of recesses 114 formed therein. In the depicted embodiment, the plurality of recesses 114 are arranged in rows and columns, however, other configurations are possible without deviating from the scope of the present invention.

As best seen in FIG. 4, first end surface 114 projects from first end edge 110 and is defined by edges 116 and 118 and upper edge 119. Edges 116 and 118 are defined by lower portions 120 and 122, respectively, which project from first end edge 110 and terminate at intersection 124. Lower portions 120 and 122 of edges 116 and 118, respectively, define lower portion 114a of first end surface 114 therebetween and are generally parallel to each other as lower portions 120 and 122 project from first end edge 110 toward intersection 124. Upper portions 126 and 128 of edges 116 and 118, respectively, extend between intersection 124 and upper edge 119 and converge toward each other as upper portions 126 and 128 of edges 116 and 118, respectively, project from intersection toward upper edge 119. Upper portions 126 and 128 of edges 116 and 118, respectively, define upper portion 114b of first end surface 114 therebetween.

Referring to FIG. 5, second end surface 134 projects from second end edge 112 and is defined by edges 136 and 138 and upper edge 139. Edges 136 and 138 are defined by lower portions 140 and 142, respectively, which project from second end edge 112 and terminate at intersection 144. Lower portions 140 and 142 of edges 136 and 138, respectively, define lower portion 134a of second end surface 134 therebetween and are generally parallel to each other as lower portions 140 and 142 project from second end edge 112 toward intersection 144. Upper portions 146 and 148 of edges 136 and 138, respectively, extend between intersection 144 and upper edge 139 and converge toward each other as upper portions 146 and 148 of edges 136 and 138, respectively, project from intersection toward upper edge 139. Upper portions 146 and 148 of edges 136 and 138, respectively, define upper portion 134b of second end surface 134 therebetween.

First side surface 154 projects from first side edge 106 and is defined between edges 116 and 136 and upper edge 159. Lower portions 120 and 140 of edges 116 and 136, respectively, define lower portion 154a of first side surface 154 therebetween and either converge toward or are generally parallel to each other as lower portions 120 and 140 of edges 116 and 136, respectively, project from first side edge 106. Upper portions 126 and 146 of edges 116 and 136, respectively, extend toward upper edge 159 and converge toward each other. Upper portions 126 and 146 of edges 116 and 136, respectively, define upper portion 154b of first side surface 154 therebetween. Upper edge 159 includes recess 161 formed therein, as hereinafter described.

Second side surface 156 projects from second side edge 108 and is defined between edges 118 and 138 and upper edge 158. Lower portions 122 and 142 of edges 118 and 138, respectively, define lower portion 156a of second side surface 156 therebetween and either converge toward or are generally parallel to each other as lower portions 122 and 142 project from second side edge 108. Upper portions 128 and 148 of edges 118 and 138, respectively, extend toward upper edge 158 and converge toward each other. Upper portions 128 and 148 of edges 118 and 138, respectively, define upper portion 156b of second side surface 156 therebetween.

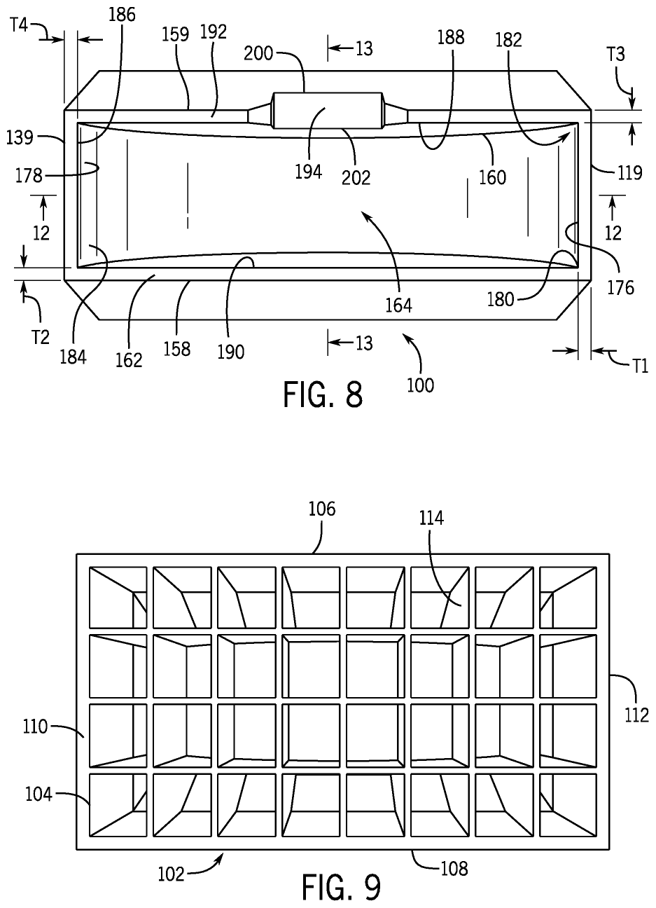

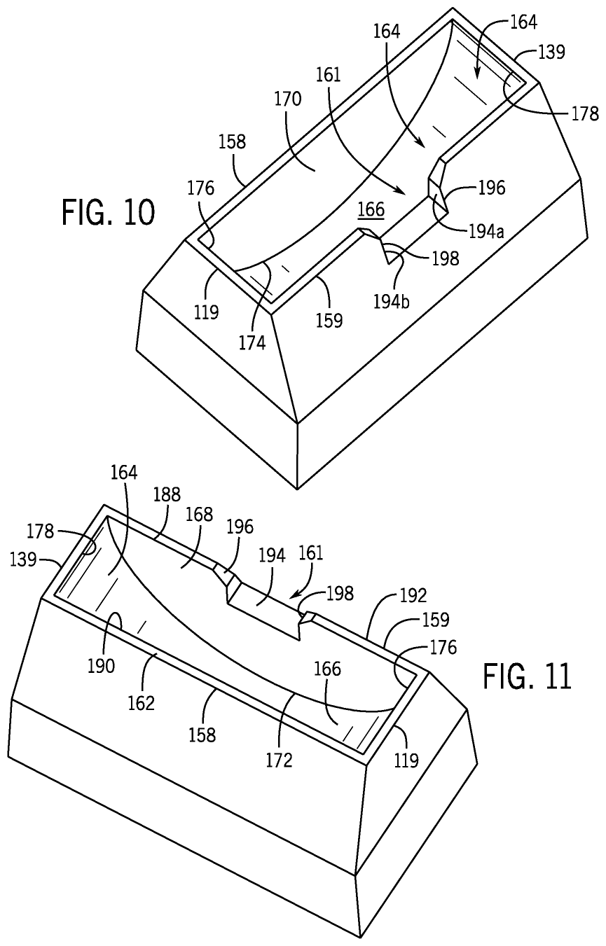

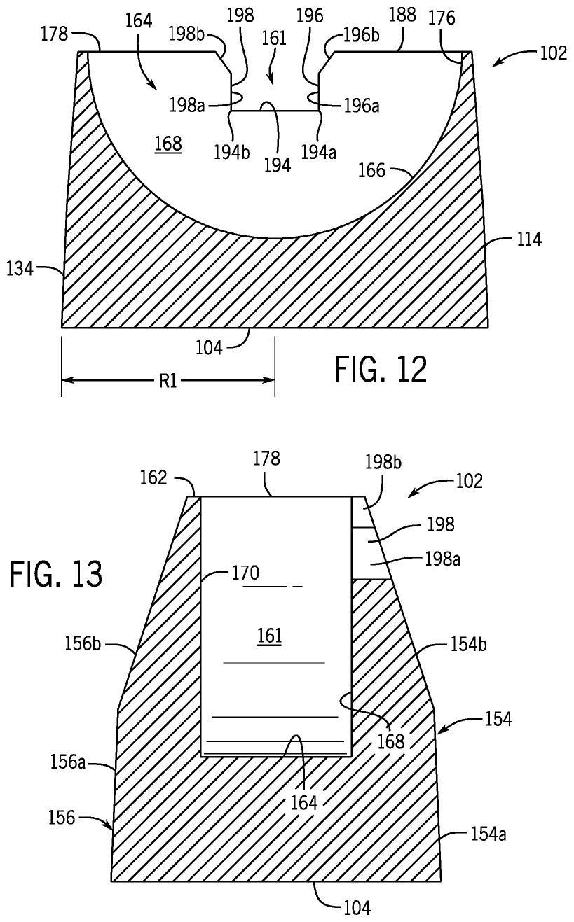

Referring to FIGS. 8 and 10-13, upper edges 119, 139, 158 and 159 define outer periphery 160 of upper surface 162 of training block 102. Upper surface 162 includes a concave recess 164 formed therein. Concave recess 164 has a semi-circular configuration and a radius R1, FIG. 12, greater than or approximately equal to radii R2 of training wheels, FIG. 1. More specifically, concave recess 164 is defined by concave peripheral surface 166 and first and second sidewalls 168 and 170, respectively. Concave peripheral surface 166 is defined by first and second side edges 172 and 174, respectively, and first and second end edges 176 and 178, respectively, which intersect upper surface 162 of training block 102, FIGS. 10-11.

Referring back to FIG. 8, first end edge 176 is generally parallel to and spaced from upper edge 119 by thickness T1. First end 180 of first end edge 176 is spaced from upper edge 159 by thickness T2 and second end 182 of first end edge 176 is spaced from upper edge 158 by thickness T3. It is also contemplated for thickness T2 to be generally equal thickness T3. Second end edges 178 is generally parallel to and spaced from upper edge 139 by thickness T4. First end 184 of second end edge 178 is spaced from upper edge 158 by thickness T2 and second end 186 of second end edge 178 is spaced from upper edge 158 by thickness T3. It is contemplated for thickness T1 to be generally equal thickness T4.

First and second sidewalls 168 and 170, respectively, extend between first and second side edges 172 and 174, respectively, and first and second upper sidewall edges 188 and 190, respectively. Edge 159 and first upper sidewall edge 188 define inner portion 192 of upper surface 162 of training block 102 therebetween. Notch or recess 161 is formed in inner portion 192 of upper surface 162 and is defined by support surface 194 which is generally parallel to and spaced from inner portion 192 of upper surface 162 by sidewalls 196 ad 198, respectively. Support surface 194 intersects upper portion 154b of first side surface 154 at intersection 200 and intersects first sidewall 168 at intersection 202.

Sidewall 196 projects between first end 194a of support surface 194 and inner portion 192 of upper surface 162 and includes lower portion 196a projecting from first end 194a of support surface 194 and upper portion 196b extending between lower portion 196a and inner portion 192 of upper surface 162. Sidewall 198 projects between second end 194b of support surface 194 and inner portion 192 of upper surface 162 and includes lower portion 198a projecting from second end 194b of support surface 194 and upper portion 198b extending between lower portion 198a and inner portion 192 of upper surface 162. Lower portions 196a and 198a of sidewalls 196 and 198, respectively, are generally parallel to each other and perpendicular to support surface 194. It is contemplated for lower portions 196a and 198a of sidewalls 196 and 198, respectively, to be spaced by a submission dimension to accommodate bracket 64 of a corresponding training wheel assembly 60 and 62 or the axle of a corresponding training wheel 68 to pass therethough. Upper portions 196b and 198b of sidewalls 196 and 198, respectively, converge toward each other as upper portions 196b and 198b of sidewalls 196 and 198, respectively, extend from inner portion 192 of upper surface 162 toward lower portions 196a and 198a of sidewalls 196 and 198, respectively. It can be appreciated the configuration of upper portions 196b and 198b of sidewalls 196 and 198, respectively, is intended to direct bracket 64 of a corresponding training wheel assembly 60 and 62 or the axle of a corresponding training wheel 68 between lower portions 196a and 198a of sidewalls 196 and 198, respectively.

Referring to FIG. 1, in operation, first and second training blocks 102 of training wheel training device 100 are positioned on opposite sides of rear wheel 34 of bicycle 10. Training wheels 68 of first and second training wheel assemblies 60 and 62, respectively, are positioned in corresponding concave recesses 164 in first and second training blocks 102 such that training wheel 68 of first wheel assembly 60 engages concave peripheral surface 166 of first training block 102 and training wheel 68 of second wheel assembly 62 engages concave peripheral surface 166 of second training block 102. With training wheels 68 of first and second training wheel assemblies 60 and 62, respectively, positioned on concave peripheral surfaces 166 of first and second training blocks 102, the outer periphery of rear wheel 34 of bicycle 10 is lifted off and spaced from supporting surface 96. As such, when a rider mounts bicycle 10 and begins pedaling pedals 97 thereof, the power generated by the user is directly transferred from pedals 97 to rear wheel 34 through chain 98 that interconnects pedals 97 to chain driven sprocket 44 of rear wheel 34, thereby causing real wheel 34 to freely rotate above supporting surface 96. As such, with bicycle 10 maintained in a stationary position by first and second training blocks 102, bicycle 10 may be used for indoor exercises. Further, it can be understood that with training wheels 68 of first and second training wheel assemblies 60 and 62, respectively, of bicycle 10 positioned on concave peripheral surfaces 166 of first and second training blocks 102, bicycle 10 is prevented from tipping over when used, thereby assisting a child to develop a sense of balance when rising bicycle 10.

Various modes of carrying out the invention are contemplated as being within the scope of the following claims particularly pointing out and distinctively claiming a subject matter which applicant regards is the invention.

We claim:

1. A training wheel training device for use in connection with a bicycle having first and second training wheels mounted thereto, comprising:
a block having a bottom surface engageable with a supporting surface and an upper surface spaced therefrom, the upper surface including a recess formed therein; and
a wheel support surface having at least a portion spaced from the upper surface and partially defining the recess, the wheel support surface adapted for receiving the first training wheel.

2. The training wheel training device of claim 1 wherein the block includes first and second sidewalls, each of the first and second sidewalls including an inner surface partially defining the recess and an upper edge partially defining the upper surface of the block.

3. The training wheel training device of claim 2 wherein the upper edge of the first sidewall includes a notch.

4. The training wheel training device of claim 3 wherein the notch is defined by first and second side surfaces interconnected by a lower surface spaced from the upper edge.

5. The training wheel training device of claim 4 wherein the first and second side surfaces include lower portions extending from opposite ends of the lower surface and upper portions between the lower portions and the upper edge.

6. The training wheel training device of claim 4 wherein the lower portions of the first and second side surfaces are generally parallel to each other.

7. The training wheel training device of claim 5 wherein upper portions of the first and second side surfaces extend from the upper edge and converge toward each other.

8. The training wheel training device of claim 1 wherein the wheel support surface is generally arcuate and has first and second ends intersecting the upper surface of the block.

9. The training wheel training device of claim 1 wherein the block is a first block and the wheel support surface is a first wheel support surface, the training wheel training device further comprising:
a second block having lower surface engageable with the supporting surface and an upper surface spaced therefrom, the upper surface of the second block including a recess formed therein; and
a second wheel support surface having at least a portion spaced from the upper surface of the second block and partially defining the recess of the second block, the second wheel support surface adapted for receiving the second training wheel.

10. A training wheel training device for use in connection with a bicycle having a training wheel, the training wheel supported by a support extending from a frame of the bicycle, comprising:
a block having lower surface engageable with a supporting surface, an upper surface spaced therefrom, a first sidewall having an upper edge and a second sidewall, the upper surface including a recess configured to receive at least a portion of the training wheel formed therein; and
a notch formed in the upper edge of the first sidewall and being configured to allow the support of the bicycle to pass therethrough, the notch communicating with the recess.

11. The training wheel training device of claim 10 further comprising a wheel support surface having at least a portion spaced from the upper surface and partially defining the recess, the wheel support surface adapted for engagement with the training wheel.

12. The training wheel training device of claim 10 wherein each of the first and second sidewalls includes an inner surface partially defining the recess and an outer surface.

13. The training wheel training device of claim 12 wherein the outer surface of the first sidewall includes a lower portion extending from the lower surface of the block and upper portion between the lower portion and the upper edge.

14. The training wheel training device of claim 10 wherein the notch is defined by first and second side surfaces interconnected by an end surface spaced from the upper edge.

15. The training wheel training device of claim 14 wherein the first and second side surfaces include lower portions extending from opposite ends of the end surface and upper portions between the lower portions and the upper edge.

16. The training wheel training device of claim 15 wherein the lower portions of the first and second side surfaces are generally parallel to each other.

17. The training wheel training device of claim 15 wherein upper portions of the first and second side surfaces extend from the upper edge and converge toward each other.

18. The training wheel training device of claim 11 wherein the wheel support surface is generally arcuate and has first and second ends intersecting the upper surface of the block.

19. A training wheel training device for use in connection with a bicycle having a first and second training wheels, each of the first and second training wheels supported by a corresponding support extending from a frame of the bicycle, comprising:
first and second blocks, each block including:
a lower surface engageable with a supporting surface, an upper surface spaced therefrom, a first sidewall having an upper edge and a second sidewall, the upper surface including a recess configured to receive at least a portion of the training wheel formed therein;
a notch formed in the upper edge of the first sidewall and being configured to allow the support of the bicycle to pass therethrough, the notch communicating with the recess; and
a wheel support surface having at least a portion spaced from the upper surface and partially defining the recess, the wheel support surface adapted for receiving a corresponding one of the first and second first training wheels thereon.

20. The training wheel training device of claim 18 wherein the first and second sidewalls of each of the first and second blocks include an inner surface partially defining the recess.

21. The training wheel training device of claim 18 wherein the notch in each of the first and second blocks is defined by first and second side surfaces interconnected by a bottom surface spaced from the upper edge.

22. The training wheel training device of claim 20 wherein the first and second side surfaces include lower portions extending from opposite ends of the bottom surface and upper portions between the lower portions and the upper edge.

23. The training wheel training device of claim 21 wherein the lower portions of the first and second side surfaces of each notch are generally parallel to each other.

24. The training wheel training device of claim 5 wherein upper portions of the first and second side surfaces of each notch extend from the upper edge of a corresponding first sidewall of the first and second blocks and converge toward each other.

25. The training wheel training device of claim 1 wherein the wheel support surface of each of the first and second blocks is generally arcuate and has first and second ends intersecting the upper surface of a corresponding first and second block.
